(19) United States
(12) Patent Application Publication
(10) Pub. No.: US 2003/0236477 A1
(43) Pub. Date: Dec. 25, 2003

(54) Massage device

(76) Inventor: Chu Chau Huang, Taipei (TW)

Correspondence Address: CHU CHAU HUANG, P.O.BOX, 26-757, TAIPEI, TW

(21) Appl. No.: 10/185,633

(22) Filed: Jun. 25, 2002

(51) Int. Cl. A61H 7/00

(52) U.S. Cl. 601/135

(57) ABSTRACT

A modified massage device comprises a handle and a plurality of massage heads. Hollow receiving spaces are formed of bottom faces of a plurality of support arms of the handle and top faces of the massage heads, respectively, to receive small object like magnets so as to indirectly enhance activation of cells, accelerate discharge of waste materials and toxins in the body, and absorb harmful magnetic waves and radiations emitted out by ambient electric appliances. The small object can also be an occasional mascot or a fluorescent decoration to enhance peacefulness and delicacy of home or the working environment.

### FIELD OF THE INVENTION

The present invention relates to a modified massage device and, more particularly, to a massage device having massage heads with small objects received therein to enhance harmonization of the body when massaging and also achieve the effects of peacefulness and delicacy.

### BACKGROUND OF THE INVENTION

Nowadays, plenty of economic life and busyness of working pace cause change in diet habit and exercise way of modern people. Increase of chronic diseases and degradation of body functions accompany therewith. These are largely because of deficiency of exercise, bad blood circulation, and accumulation of waste materials in the body. Massage is a way to keep in good health and a rehabilitation therapy popular at all times and in all countries. Through massage at points in the human body where nerve centers are supposed to be located, muscles can be relaxed to take away fatigue and stimulate blood circulation. There are already many auxiliary tools for massage in the market. However, only a massage tool of easy operation and convenient portability and without the need of spare power and special maintenance can meet the requirements of modern people. As shown in FIG. 1, a conventional massage device 1 comprises a handle 11, a plurality of support arms 12, and a plurality of massage heads 13. The massage device 1 can have various kinds of shapes according to ergonomics of handheld ways and massaged portions. This kind of light and portable massage device 1 has only basic contact massage function. It directly stimulates various portions of the body to take away muscle aches and enhance blood circulation.

However, the above conventional massage device has a shape designed according to ergonomics, and has only a single massage function of kneading. Moreover, because of little profit under keen competition environment, the production motive of the manufactures declines sharply.

Accordingly, the above conventional massage device has inconvenience and drawbacks in practical manufacturing and use. The present invention aims to provide a modified massage device to resolve the problems in the prior art.

### SUMMARY OF THE INVENTION

The primary object of the present invention is to provide a modified massage device, which comprises a handle and a plurality of massage heads. Small objects like magnets can be placed in the massage heads to enhance harmonization of the body and provide magnetic field when massaging. Another object of the present invention is to provide a modified massage device, which comprises a handle and a plurality of massage heads. Small objects like magnets can be placed in the massage heads to absorb harmful magnetic waves and radiations of ambient electric appliances when the modified massage device is not in use.

Anther object of the present invention is to provide a modified massage device, which comprises a handle and a plurality of massage heads. Small objects like occasional mascots or fluorescent decorations can be placed in the massage heads to enhance delicacy of home or the working environment and increase added values.

To achieve the above objects, the present invention provides a modified massage device, which comprises a handle and a plurality of massage heads. A plurality of support arms are extended from the handle. An upper cavity is disposed on a bottom face of each of the support arms. A lower cavity is disposed on a top face of each of the massage heads. The upper cavity corresponds to and mates the lower cavity to form a hollow receiving space for receiving a small object.

The various objects and advantages of the present invention will be more readily understood from the following detailed description when read in conjunction with the appended drawing, in which:

### BRIEF DESCRIPTION OF THE DRAWINGS

FIG. 1 is a perspective view of a conventional massage device;

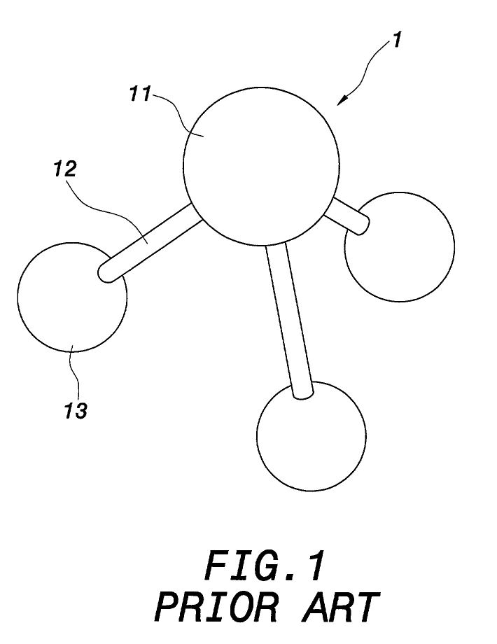

FIG. 2 is an exploded perspective view of a first embodiment of the present invention;

FIG. 3 is a perspective assembly view of the first embodiment of the present invention;

FIG. 4 is a side cross-sectional view of the first embodiment of the present invention;

FIG. 5 is a perspective assembly view of a second embodiment of the present invention;

FIG. 6 is a perspective assembly view of a third embodiment of the present invention;

FIG. 7 is a perspective assembly view of a fourth embodiment of the present invention; and

FIG. 8 is a perspective assembly view of a fifth embodiment of the present invention.

### DETAILED DESCRIPTION OF THE PREFERRED EMBODIMENTS

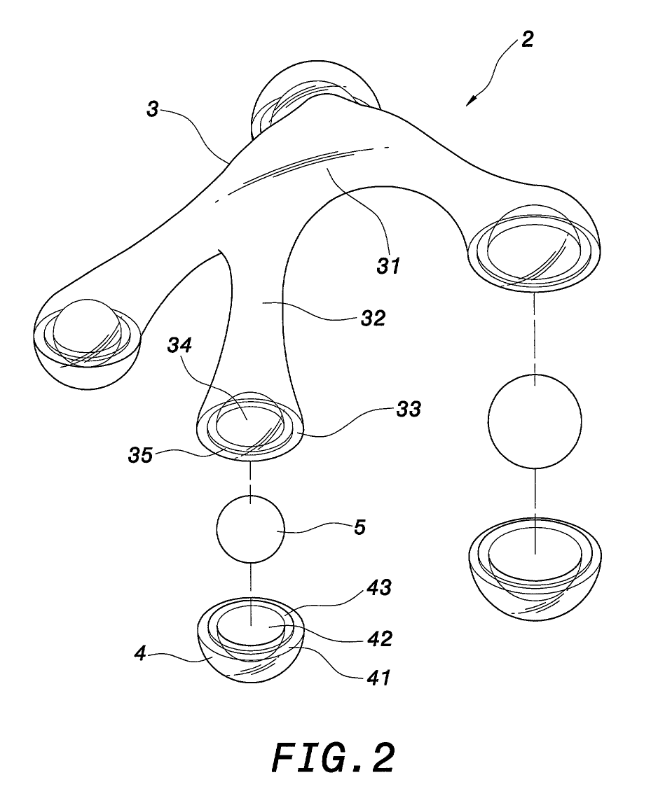

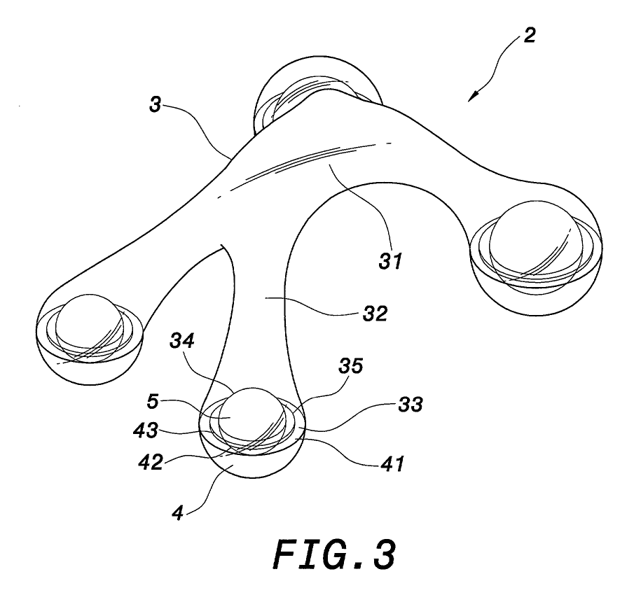

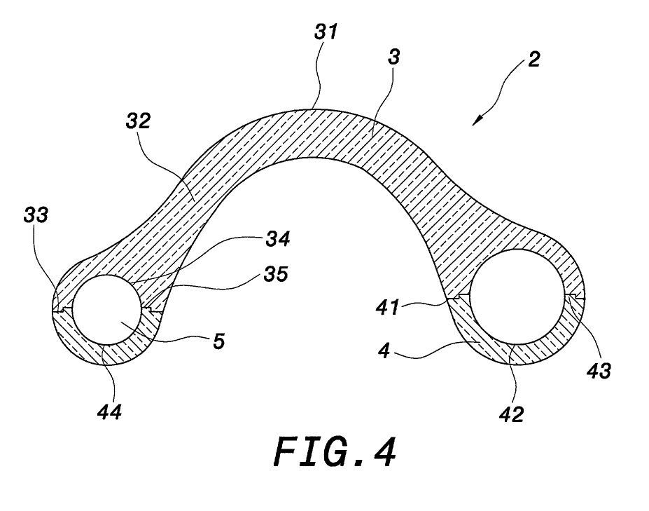

As shown in FIGS. 2 to 4, a modified massage device 2 of the present invention comprises a handle 3 and a plurality of massage heads 4.

The handle 3 has a top face 31, which is a smooth curved plane to conform to ergonomics of palm and fingers. A plurality of support arms 32 are extended from the lower edge of the handle 3. An upper cavity 34 is disposed at a bottom face 33 of each of the support arms 32. A retaining groove 35 is formed at the periphery of the upper cavity 34.

The massage head 4 has a top face 41 with a lower cavity 42. A retaining flange 43 is disposed at the periphery of the lower cavity 42. The top face 41, the lower cavity 42, and the retaining flange 43 of the massage head 4 respectively correspond to the bottom face 33, the upper cavity 34, and the retaining groove 35 of the support arm 32 to form a hollow receiving space 44.

A magnet 5 can be placed in the lower cavity 42 of the massage head 4. The retaining flange 43 of the massage head 4 and the magnet 5 are then embedded into the retaining groove 35 and the upper cavity 34 of the bottom face 33 of the support arm 32 for fixation. When the massage device 2 is used for kneading, the massage head 4 directly stimulates the contacted portion of the body to achieve the effects of looseness of meridians, relaxation of pressure, improvement of blood circulation, and enhancement of metabolism. The magnet 5 placed in the receiving space 44 is exploited to indirectly enhance activation of cells, slow down aging of skin and flesh, accelerate discharge of waste materials and toxins in the body so as to let the body be more comfortable and the spirit be more relaxed. When the massage device 2 is not in use, the magnet 5 in the receiving space 44 can absorb harmful magnetic waves and radiations emitted out by ambient electric appliances.

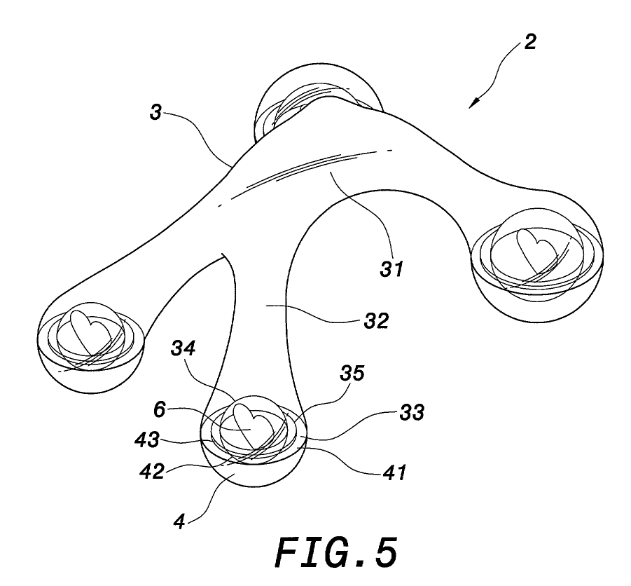

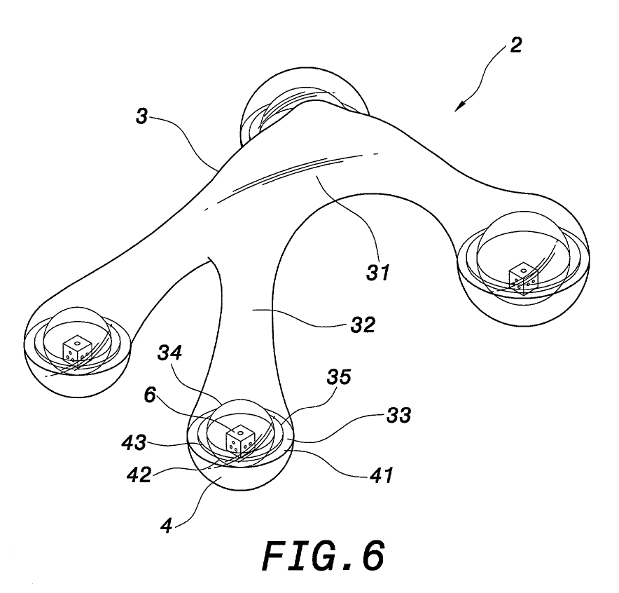

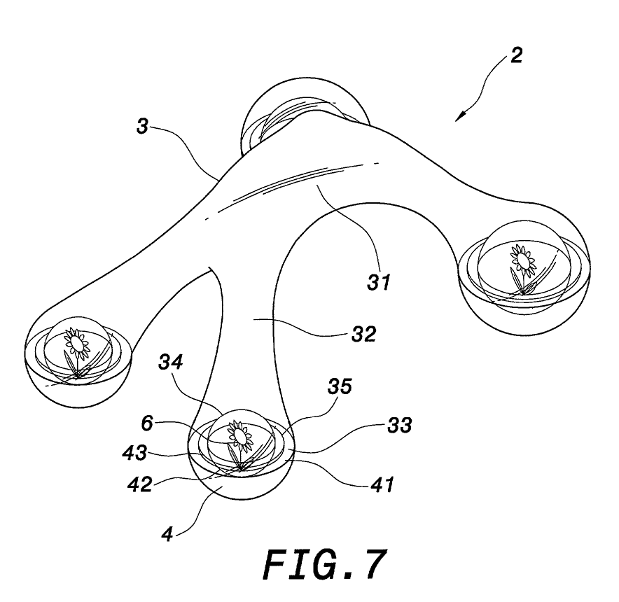

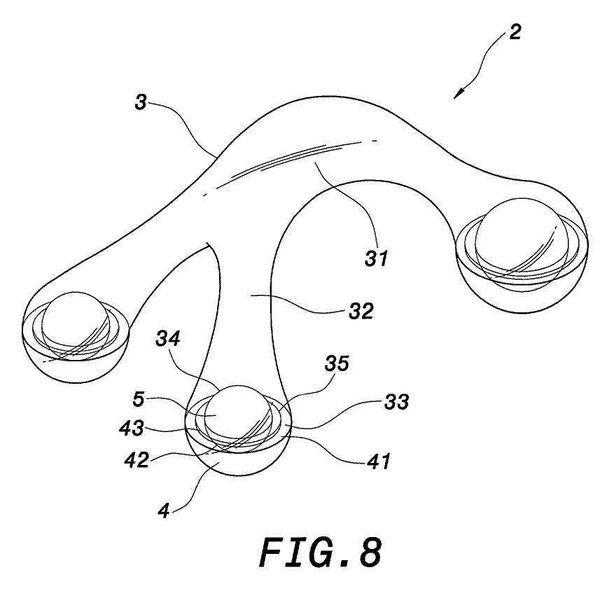

As shown in FIGS. 5 to 8, various kinds of small objects of different shapes like occasional mascots or fluorescent decorations can be placed in the receiving spaces 44 simultaneously to enhance delicacy of home or the working environment and increase added values.

To sum up, the modified massage device of the present invention has the following characteristics.

1. The receiving space formed by the bottom face of the support arm of the handle and the top face of the massage head can receive a small object like a magnet to indirectly enhance activation of cells, slow down aging of skin and flesh, accelerate discharge of waste materials and toxins in the body so as to let the body be more comfortable and the spirit be more relaxed.

2. The receiving space formed by the bottom face of the support arm of the handle and the top face of the massage head can receive a small object like a magnet to absorb harmful magnetic waves and radiations emitted out by ambient electric appliances.

3. The receiving space formed by the bottom face of the support arm of the handle and the top face of the massage head can receive a small object like an occasional mascot or a fluorescent decoration to enhance delicacy of home or the working environment and increase added values.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A massage device comprising:
a handle with a plurality of support arms extended therefrom, a bottom face of each of said support arms having an upper cavity; and
a plurality of massage heads, a top face of each of said massage heads having a lower cavity, said top face and said lower cavity of said massage head mating said bottom face and said upper cavity of said support arm to form a hollow receiving space for receiving a small object.

2. The massage device as claimed in claim 1, wherein a retaining groove is disposed at the periphery of said upper cavity of said bottom face of said support arm, a retaining flange is disposed at the periphery of said lower cavity of said top face of said massage head, and said retaining flange being embedded into said retaining groove to fixedly connect said massage head and said handle.

3. The massage device as claimed in claim 1, wherein said small object is a magnet.

4. The massage device as claimed in claim 1, wherein said small object is a rock crystal.

5. The massage device as claimed in claim 1, wherein said small object is a pearl.

6. The massage device as claimed in claim 1, wherein said small object is coral.

7. The massage device as claimed in claim 1, wherein said small object is an occasional mascot in festivals.

8. The massage device as claimed in claim 1, wherein said small object is a fluorescent decoration.
